(19) United States
(12) Patent Application Publication
(10) Pub. No.: US 2018/0003891 A1
(43) Pub. Date: Jan. 4, 2018

(54) OPTICAL ELEMENT AND METHOD OF MANUFACTURING OPTICAL ELEMENT

(71) Applicant: Konica Minolta, Inc., Tokyo (JP)

(72) Inventors: Kazuhiro Wada, Tokyo (JP); Hideyuki Fujimori, Tokyo (JP)

(73) Assignee: Konica Minolta, Inc., Tokyo (JP)

(21) Appl. No.: 15/543,807

(22) PCT Filed: Jan. 14, 2016
(86) PCT No.: PCT/JP2016/050918

§ 371 Date: Jul. 14, 2017

(30) Foreign Application Priority Data
Jan. 15, 2015 (JP) 2015-005885

(51) Int. Cl. G02B 6/02; B29C 45/00; B29C 45/73; G02B 1/04

(52) U.S. Cl. CPC G02B 6/02295; G02B 1/04; B29C 45/0013; B29C 45/73; B29C 2045/7356

(57) ABSTRACT

An optical element is configured to transmit a light flux emitted from a light source having a single light source wavelength, and is formed from a material in which resin and glass fillers are mixed. A difference between respective refractive index change rates (dn/dT) of the resin and the glass fillers relative to a temperature change at least in a vicinity of the light source wavelength becomes 10.5×10⁵ or less.

### TECHNICAL FIELD

The present invention relates to an optical element used suitably, for example, for optical communication and a method of manufacturing an optical element.

### BACKGROUND ART

In various information/signal processing apparatuses which include network devices, such as routers, servers, and large size computers, information/signal processing has be being made larger in scale and faster in speed. In these apparatuses, conventionally, signal transmission between a CPU and memories on a circuit substrate (board), between wiring boards, and between devices (rack), has been performed with electric wiring. However, in place of the above electric wiring, so-called optical interconnection that transmits signals with light rays via a transmission passage such as optical fibers, is actually beginning to be introduced from superiority in the viewpoints of a transmission rate, transmission capacity, power consumption, radiation from a transmission passage, interference of electromagnetic waves for a transmission passage, and the like.

In such optical interconnection, an optical transmitting module including light emitting elements which converts electric signals into optical signals and transmits the optical signals, and an light receiving module including light receiving elements which receives optical signals and converts the optical signals into electrical signals, or an optical transceiver modules which have the both functions of them, are used as main optical components. These modules are collectively referred to as an optical module.

In the case where optical signals are transmitted in parallel via transmission channels between optical modules, large amount communication becomes possible. In order to perform transmission/reception of optical signals in parallel between optical modules, optical fibers are used as the transmission channels in many cases. Accordingly, for optical coupling between the optical fibers and the optical modules, an optical coupling apparatus is generally used.

Incidentally, since optical fibers have fleibility basically, a certain amount of bending or slackening may be permitted. However, in general optical fibers, the minimum diameter of bending permissible is specified in order to secure the transmission efficiency of light. Accordingly, in the case where bending equal to or smaller than a minimum diameter is required due to restriction of an installation space, optical fibers are cut out, and an optical coupling apparatus is used so as to perform optical coupling by bending an optical path of a light flux transmitted between the cut-out optical fibers. The above technique leads to effective accommodation as a whole and enhancement of optical transmission efficiency. The merit of using such an optical coupling apparatus may arise, without being limited to the optical coupling between the optical fibers, similarly in optical coupling between light emitting elements and optical fibers, or between optical fibers and light receiving elements. Here, the light emitting element, the light source, the light receiving element, etc. are collectively called an optical element.

In order to perform optical coupling between optical elements, an optical connector with a structure to bend an optical path may be used for an optical coupling apparatus. As such an optical connector, a PT optical connector (standardized by JPCA-PE03-01-06S) configured to change an optical axe by 90 degrees in the inside of the connector has been put in practical use. The PT optical connector is a board-mounting type optical connector which optically couples multi-core optical fibers, such as multi-core optical fiber tape core wires, with optical elements on a flexible wiring board.

On the other hand, in recent years, the amount of optical communication information has been increasing steadily, and in addition, long distance and high-speed transmission of information has been highly desired. However, in the case of multimode fibers having been used conventionally, two types of optical fibers with the respective core diameters of 50·m and 62.5·m has been adopted. Accordingly, since optical signals are transmitted in two or more modes, problems arise in that a deviation occurs in the arrival time of signals and mode dispersion occurs. Therefore, since the mode dispersion causes data loss, the above multimode fibers are considered not to be suitable for long distance and high-speed transmission.

In contrast, single mode fibers are extremely small diameter optical fibers with a mode field diameter of 9.2·m. Accordingly, propagation of optical signals is made into a single mode, whereby there is an advantage that attenuation can be suppressed as much as possible.

Therefore, unlike the transmission method which uses many modes like multimode fibers, the signal arrival time is single. Accordingly, since mode loss does not occur, and the single mode fibers are suitable for long distance and high-speed transmission, opportunities to use the single mode fibers has been increasing.

However, at the time of using single mode fibers, there is difficulty in assembly. That is, since the mode field diameter of the single mode fibers is as small as 9.2·m, at the time of optically coupling optical fibers with an optical element by using an optical connector, tolerance for positional deviation becomes narrower, and the difficulty in assembly increases. Particularly, difficulties may arise in the case of optically coupling multi-core optical fibers capable of transmitting information independently through two or more cores with two more optical elements by using a single optical connector. An optical connector used for such applications generally includes two or more lens surfaces to propagate light to optical fibers and optical elements. In the case where such an optical connector is formed from resin, for example, with thermal expansion due to an environmental temperature change, a deviation arises between a distance between cores of optical fibers and a space between lens surfaces, whereby there is a fear that optical coupling cannot be performed between some optical fibers and the optical element. On the other hand, in order to suppress light loss at the time of information transmission, it is necessary for the optical connector to secure high transparency (transmittance) to some extent.

In the case where glasses are used as raw materials of the optical connector, since a thermal expansion difference approaches relative to the optical fibers while maintaining high transparency, a deviation between a distance between cores of optical fibers and a space between lens surfaces can be suppressed. However, since glass is inferior in moldability as compared with resin, the glass is not suitable for mass production, and an increase is cost is induced.

Thus, as shown in PTLs 1 and 2, a trial has been made to form optical elements with raw materials made to approach the characteristics of glasses by mixing glass fillers into resin.

### CITATION LIST

### Patent Literature

PTL 1: Japanese Unexamined Patent Publication No. 2006-312706

PTL 2: Japanese Unexamined Patent Publication No. 2006-169324

According to PTLs 1 and 2, a technique is disclosed that increases mechanical strength by mixing glass fillers into resin and, further, secures the transparency of the resin by making refractive index approach that of glass. However, the raw materials disclosed by the above-mentioned conventional techniques are those used for molded-product required to satisfy the both physical properties of transparency and strength, for example, like a cover of a display of each of electric devices and electronic devices and a replacement article of a plate glass used for vehicles and construction materials. The above-mentioned conventional techniques teach nothing about the effects of transmitting light rays of a single light source wavelength used for optical communication.

### SUMMARY OF INVENTION

One or more embodiments of the present invention provide an optical element that is used for applications to transmit a single light source wavelength, can secure high light utilization efficiency, and is stable relative to an external environment and a method of manufacturing the optical element.

An optical element reflecting one or more embodiments of the present invention is an optical element to transmit a light flux emitted from a light source having a single light source wavelength, wherein the optical element is formed from a material in which resin and glass fillers are mixed, and a difference between respective refractive index change rates (dn/dT) of the resin and the glass fillers relative to a temperature change at least in a vicinity of the light source wavelength becomes 10.5×10⁵ or less.

Hereinafter, a principle according to one or more embodiments of the present invention is described. In the pre-study of the present inventors, the following matters have been supposed. That is, by mixing resin materials and glass fillers, transmittance becomes to change relative to wavelength, and a wavelength (referred to as a peak wavelength) at which transmittance becomes highest, occurs. However, the above phenomena are not changed regardless of the mixing amount. On the other hand, in the case of an optical element used for optical communication etc., since a light source wavelength has been determined beforehand, it can be said that it is not necessary to secure transmittance on the entire wavelength band. Therefore, in the design of an optical element for a single light source wavelength, for example, in order to adjust a linear expansion coefficient, a policy to use resin raw material into which glass fillers are suitably mixed has been determined. However, in the resin raw material into which glass fillers are mixed, it has become clear that a phenomenon in which transmittance changes when temperature changes, occurs. This phenomenon is described concretely. Hereinafter, in this specification, the term “refractive index (index of refraction)” used without being specified especially, is referred to refractive index at a normal temperature (25° C.). Incidentally, since it is permissible that resin material and glass fillers are just mixed, the expression “mix” is used. However, usually, glass fillers are mixed into resin material. Accordingly, in this description, description may be also given by using the expression “mix into or mixed into”.

FIG. 1 is a diagram in which an axis of ordinate indicates transmittance and an axis of abscissa indicates wavelength, and which shows a result of the investigation of transmittance for each wavelength which was performed by making transmission light rays with respective varied wavelengths transmit through a test piece with a thickness of 3 mm made of resin into which 30 wt % glass fillers were mixed, while changing the ambient temperature. According to FIG. 1, it turns out that as the ambient temperature of a molded-product becomes higher, a peak wavelength shifts to the short wavelength side, and furthermore, the transmittance at the supposed peak wavelength (in this case, 589 nm) decreases. On the other hand, in the pre-study, it has not been supposed that in the resin raw material according to the design specification of an optical element, such a phenomenon would arise.

The present inventors have considered about a cause of a difference occurred in optical properties between the design specification and the actual resin raw material. FIG. 2 is a schematic diagram viewing an enlarged resin into which glass fillers are mixed. In resin PL, a number of rod-like bodies of glass fillers GF are arranged so as to overlap each other. Here, considering a molding process of resin into which glass fillers are mixed, the resin into which with the glass fillers are mixed is first heated to around 300° C., injected into a mold heated to around 120° C., solidified, and thereafter, left at a room temperature of around 20° C. Then, the cooling is progressing according to the temperature environment under which the resin is placed in the above way. At that time, it is presumed that the restraint by the mixed-into glass fillers prevents the contraction of the resin being positioned in the vicinity of the glass fillers, which causes un-uniformity in the resin density. In concrete terms, it is presumed that, for example, in the inside of a resin molded-product, since the restraint by glass fillers is strong, the resin density becomes rough, on the other hand, in a portion near to the surface of the resin molded-product, since the restraint by the glass fillers is weak, the resin density becomes dense. Accordingly, it may be considered that, since the glass filler itself has seldom denatured, the refractive index change of the glass fillers is small as compared with that of the resin, in contrast, the refractive index of the resin changes locally in accordance with its density. In the design specification, it has been assumed that the refractive index of resin itself is constant irrespective of location.

FIG. 3 is a diagram in which an axis of ordinate indicates a refractive index, and an axis of abscissa indicates wavelength. The present inventors have presumed that the original refractive index/wavelength characteristic of each of the resin PL and the glass fillers GF are such linear characteristics that as the wavelength·of any of the transmission light rays becomes higher, the refractive index n becomes lower, on the condition that the wavelength is limited to a narrow wavelength band (for example, the light source wavelength ±100 nm etc.). However, actually, since it is presumed that the mixing-in of the glass fillers GF makes the refractive index of the resin PL change locally, it may be considered that the refractive index/wavelength characteristic of the resin PL becomes a wide belt-shaped region PCr which varies within a predetermined range as shown with hatching in FIG. 3. Therefore, it is presumed that a peak wavelength at the time of normal temperatures is located at a position of a point PK1 at which the refractive index characteristics PCc composed of a density amount most distributed in the belt-shaped region PCr intersects with the refractive index/wavelength characteristic line GC of the glass fillers GF indicated with a dotted line.

Moreover, it is presumed that since the glass fillers GF are dispersed in a portion of the inside of the molded-product where the refractive index distribution is comparatively large, wavelengths passing through the respective glass fillers become different, which results in one of factors to lower the whole transmittance.

In contrast, when temperature rises, each of the density of the resin PL and the density of the glass fillers GF changes. Therefore, it is considered that the refractive index/wavelength characteristic of the resin PL becomes a belt-shaped region PCrt which has shifted to a short wavelength side while keeping variation in the predetermined range as shown in FIG. 3. Moreover, since the density of the glass fillers GF lowers though slightly with the rising of the temperature, the refractive index also lowers according to this, and shifts as shown with a continuous line in FIG. 3. Therefore, it is presumed that a peak wavelength when temperature rises is located at a position of a point PK2 at which the refractive index characteristics PCct composed of a density amount most distributed in the belt-shaped region PCrt in the resin PL intersects with the refractive index/wavelength characteristic line GCt of the glass fillers GF.

FIG. 4 is a diagram in which an axis of ordinate indicates transmittance and an axis of abscissa indicates wavelength, and which shows schematically the characteristics of resin into which glass fillers are mixed, at the time (A) of normal temperatures and at the time of rising of temperature. In any case, although transmittance distribution is caused, the distribution here is made into Gaussian distribution centered at the peak wavelength. As mentioned above with reference to FIG. 3, in the case where the temperature rises from the normal temperature, the peak wavelength PK1 shifts to the peak wavelength PK2 on the lower wavelength side than its wavelength. At this time, it turns out that if a single light source wavelength is assumed to be PK1, since the resin raw material follows the characteristics (B) at the time of rising of the temperature, the transmittance lowers by ·.

According to the examination results of the present inventors, the following matters have been turned out. That is, in the molded-product actually molded with the resin with the mixing amount of the glass fillers of 30 wt %, the peak wavelength at 28° C. was 503 nm, and the transmittance was 52.1%. On the other hand, in the case where the temperature of the above molded-product was increased to 40° C., the peak wavelength became 490 nm, and the transmittance lowered to 51.7%. Furthermore, in the case where the temperature of the above molded-product was increased to 49° C., the peak wavelength became 480 nm, and the transmittance at a wavelength of 503 nm lowered to 51.4%. Moreover, in the case where the temperature of the above molded-product was increased to 56° C., the peak wavelength became 476 nm, and the transmittance lowered to 51.2%.

From the above examination results, the present inventors have found out that advantages over conventional art can be achieved by devising the refractive index change rate of each of resin and glass fillers to be mixed into relative to a temperature change. In more concrete terms, in FIG. 3, in the case where the peak wavelength PK1 at the time of normal temperature overlaps the peak wavelength PK2 at the time of the rising of temperature, the lowering of the transmittance can be suppressed as much as possible. In other words, in FIG. 5 in which an axis of ordinate indicates a refractive index and an axis of abscissa indicates wavelength, in the case where a point PK2 at which the refractive index characteristics PCct composed of a density amount most distributed in the belt-shaped region PCrt in the resin PL at the time of the rising of temperature intersects with the refractive index/wavelength characteristic line GCt of the glass fillers GF is made to overlap, on the axis of abscissa, a point PK1 at which the refractive index characteristics PCc composed of a density amount most distributed in the belt-shaped region PCr in the resin PL at the time of normal temperature intersects with the refractive index/wavelength characteristic line GC of the glass fillers GF, the variation or deviation of the peak wavelength can be suppressed irrespective of a temperature change. Furthermore, even if the peak wavelengths PK1 and PK2 do not coincide with each other perfectly, if a difference between them is small, there may be a certain effect.

Namely, in the case where glass fillers to be mixed into and resin are appropriately selected such that a difference between the respective refractive index change rates (dn/dT) relative to a temperature change becomes 10.5×10⁻⁵ or less, in an optical element molded by the selected raw materials, a shift amount of the peak wavelength at the time of the rising of the temperature relative to the peak wavelength at the time of the normal temperature can be suppressed as small as possible, whereby the lowering of transmittance can be suppressed.

In the case of optical element applications for the purposes of transmission of light of an object to be imaged, display of a color image, and the like, since the entire wavelength region of the visible light region is needed, it may be considered to select materials such that the respective refractive indexes of the glass fillers and the resin become as the same as possible on the entire wavelength region. However, in one or more embodiments, since a single light source is used, different from the optical element application for the purposes of transmission of light of an object to be imaged, display of a color image, and the like, it is permissible not to make the respective refractive indexes of the glass fillers and the resin become as the same as possible. Rather, at least in the vicinity of a light source wavelength, in the case where the refractive index change rate (dn/dT) relative to a temperature change is made to 10.5×10⁻⁵ or less, it can be used for the optical element in one or more embodiments. Here, the term “in the vicinity of a light source wavelength” means a range of ±100 nm relative to a light source wavelength. Furthermore, in the case of calculating do/dT, a primary or secondary approximate curve based on the refractive index in the vicinity of the light source wavelength may be used.

An optical element reflecting one or more embodiments of the present invention is an optical element configured to transmit a light flux emitted from a light source having a single light source wavelength, wherein the optical element is formed from a material in which resin and glass fillers are mixed, and a difference between the respective linear expansion coefficients of the resin and the glass fillers at least in an operating temperature range of the optical element becomes 6.0×10⁻⁵ or less.

As is clear from the above-mentioned description, in the case where the glass fillers and the resin are selected appropriately such that a difference between the respective linear expansion coefficients of the resin and the glass fillers at least in an operating temperature range of the optical element becomes 6.0×10⁻⁵ or less, a shift amount of a peak wavelength at the time of changing of temperature (rising or lowering) relative to a peak wavelength at the time of normal temperatures in an optical element molded by using such materials can be suppressed as small as possible, whereby the lowering of transmittance can be suppressed. Moreover, since a difference of the respective linear expansion coefficients of the resin and the glass fillers is 6.0×10⁻⁵ or less, at the time of the changing of temperature (rising or lowering), the glass fillers expands or contracts similar to the resin. With this, it becomes possible to suppress the expansion or contraction of the resin in the vicinity of the glass fillers from being interrupted by the restraint by the glass fillers. Therefore, for example, it becomes possible to prevent the resin density from being variously distributed in the inside of a resin molded-product, and it becomes possible to suppress the refractive index/wavelength characteristic of the resin from becoming a wide belt shape, whereby the lowering of transmittance can be suppressed. In the case where this optical element is used as an optical connector, it is desirable to further match the respective linear expansion coefficients of an optical element and an optical fiber side. Here, the term “operating temperature range (used temperature range)” refers to a range of −20° C. to 85° C.

A method of manufacturing an optical element reflecting one or more embodiments of the present invention is a method of manufacturing an optical element that is configured to transmit a light flux emitted from a light source having a single light source wavelength and is formed from a material in which resin and glass fillers are mixed, the method includes:

a mixing process of mixing resin and glass fillers such that a difference between respective refractive index change rates (dn/dT) of the resin and the glass fillers relative to a temperature change at least in a vicinity of the light source wavelength becomes 10.5×10⁵ or less;

a process of injecting the mixed raw materials into a cavity formed in a mold;

a process of cooling the mixed raw material in the mold so as to mold an optical element; and

a process of taking out the molded optical element.

A method of manufacturing an optical element reflecting one or more embodiments of the present invention is a method of manufacturing an optical element that is configured to transmit a light flux emitted from a light source having a single light source wavelength and is formed from a material in which resin and glass fillers are mixed, the method includes:

a mixing process of mixing resin and glass fillers such that a difference between respective linear expansion coefficients of the resin and the glass fillers at least in an operating temperature range of the optical element becomes 6.0×10⁻⁵ or less;

a process of injecting the mixed raw materials into a cavity formed in a mold;

a process of cooling the mixed raw material in the mold so as to mold an optical element; and

a process of taking out the molded optical element.

### Advantageous Effects of Embodiments of the Invention

According to one or more embodiments of the present invention, it is possible to provide an optical element that is used for transmitting a single light source wavelength, can secure high light utilization efficiency, and is stable relative to an external environment and a method of manufacturing the optical element.

### BRIEF DESCRIPTION OF DRAWINGS

FIG. 1 is a diagram showing a situation that, in resins in which the mixing amount of glass fibers has been changed, a peak wavelength of transmission light shifts due to a temperature change, and transmittance tends to lower.

FIG. 2 is a schematic diagram which looks resin into which glass fibers are mixed, by enlarging it.

FIG. 3 is a diagram sowing a situation that, in resin into which glass fibers are mixed, a peak wavelength of transmission light lowers due to a temperature rise.

FIG. 4 is a diagram sowing a situation that, in resin into which glass fibers are mixed, a peak wavelength of transmission light lowers due to a temperature rise.

FIG. 5 is a diagram for describing the principle in accordance with one or more embodiments of the present invention.

FIG. 6 is a perspective view showing a state where an optical coupling apparatus 100 according to one or more embodiments is disassembled.

FIG. 7 is a cross sectional view taken along one optical axis of the optical coupling apparatus 100.

FIG. 8 is a perspective view of an optical path changing element 120 used for the optical coupling apparatus 100.

FIG. 9 is an expanded cross sectional view of the optical path changing element 120.

FIGS. 10A and B are an illustration showing a process of molding an optical path changing element with a resin into which glass fiber are mixed.

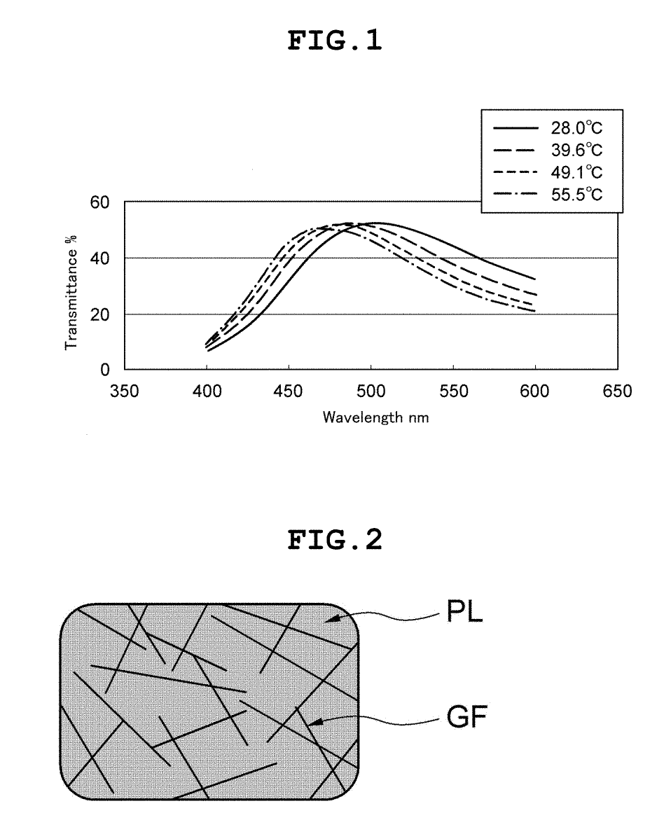

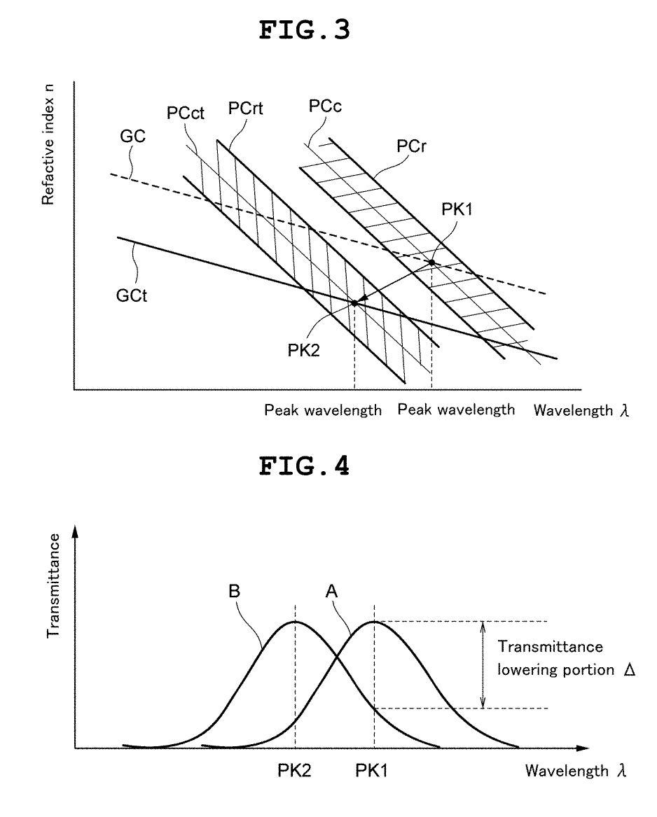

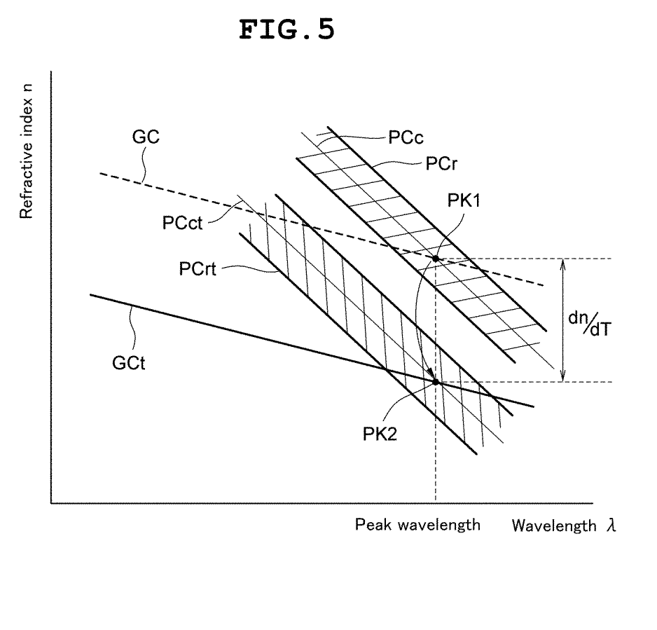

### DESCRIPTION OF EMBODIMENTS

In one or more embodiments, the term “single light source wavelength means that a light source wavelength used for a specific purpose is single. For example, in optical communication etc., even in the case where the same optical element is used for an uplink communication and a downlink communication, there may be a case where light source wavelengths may differ. In such a case, it means that the light source wavelength at the time of the uplink communication is single, and the light source wavelength at the time of the downlink communication is single.

As glass fillers, a general-purpose E glass, C glass, A glass, S glass, D glass, NE glass, T glass, silica glass, etc. may be used. For example, it may be possible to use those prepared by selecting materials from silicon dioxides (SiO₂), aluminum oxides (Al₂O₃), calcium oxides (CaO), titanium oxides (TiO₂), boron oxides (B₂O₃), magnesium oxides (MgO), zinc oxides (ZnO), barium oxides (BaO), zirconium dioxides (ZrO₂), lithium oxides (Li₂O), sodium oxides (Na₂O), potassium oxides (K₂O), etc., and by adjusting the ratio of each of the selected materials.

In one or more embodiments, as the glass fillers, glass fibers (glass fibers), glass powders, glass flakes, milled fibers, or glass beads may be used. In the embodiments and examples mentioned below, description is given to glass fibers as a representative of the glass fillers.

The glass fibers can be obtained by using well-known methods of spinning long glass fibers. For example, glasses can be made into fibers by using various kinds of methods, such as the direct melt (DM) method in which glass raw materials are continuously made to glasses in a melting furnace and the resulting glasses are introduced to a forehearth and spun with bushings attached to the bottom of the forehearth, and the remelting method in which melted glasses are molded in the form of a marble, a caret, or a bar and the molded glasses are remelted and spun.

Although the diameter of a glass fiber is not particularly limited, a diameter of 5 to 50·m is preferably used. The diameter thinner than 0.5·m increases the contact area between glass fibers and resin and causes irregular reflection, which may result in that the transparency of a molded-product lowers. On the other hand, the diameter thicker than 50·m increases a filling pressure at the time of injection molding, which may lead to the insufficient transfer to a mold. The diameter is more preferably 10 to 45·m.

It should be noted that it is important that the glass fillers contain 90% or more (preferably 95% or more) particles with sizes larger than a light source wavelength relative to the whole of the glass fillers. Until now, it has been tried to mold an optical element by using resin material into which, for example, particles with diameters of 30 nm or less are mixed. However, there has been a problem that particles tend to aggregate in this resin material, there has been another problem that the surface area of particles increase and the resin material tends to become hard so that the molding becomes difficult, and furthermore, there has been still another problem that the increased surface area of particles makes the hydrophilicity higher so that the water absorption rate of the molded optical element increases and the optical properties change. On the other hand, these problems can be solved by making the glass fillers into particles larger than a light source wavelength.

Here, examples of the “optical element” include, without being limited thereto, a lens, a prism, a diffractive grating element (a diffractive lens, a diffractive prism, a diffractive plate), an optical filter (a spatial low pass filter, a wavelength band pass filter, a wavelength low pass filter, and a wavelength high pass filter, etc.), a polarizing filter (an analyzer, an azimuth rotator, a polarizing separation prism, etc.), and a phase filter (a phase plate, a hologram, etc.).

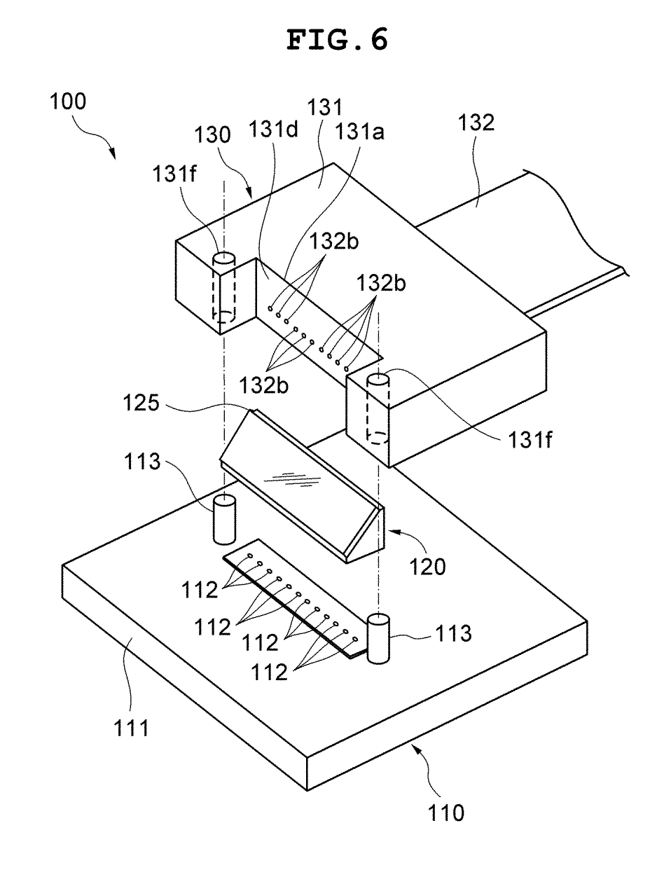

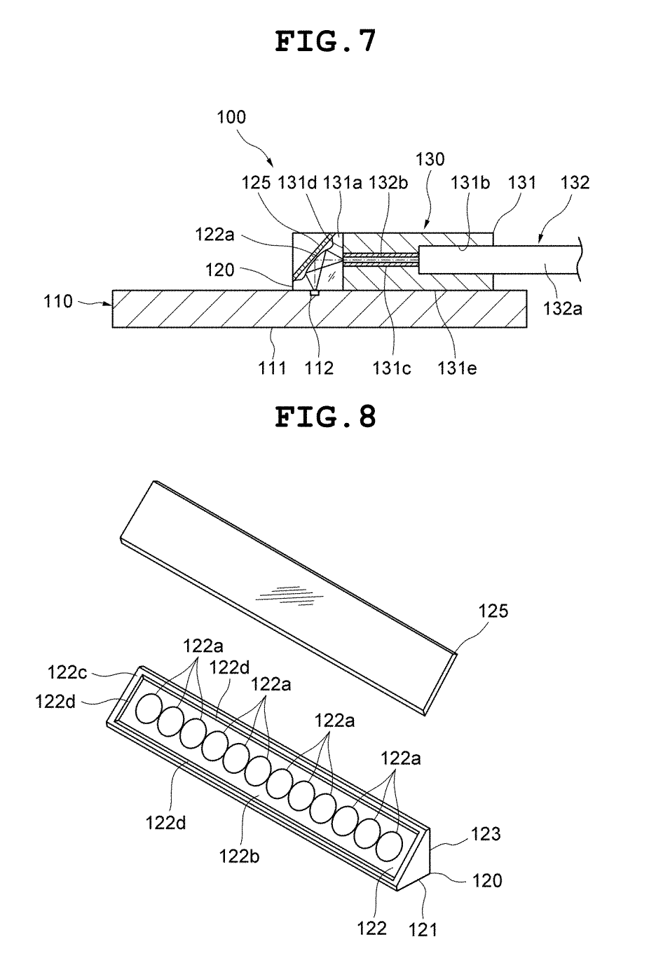

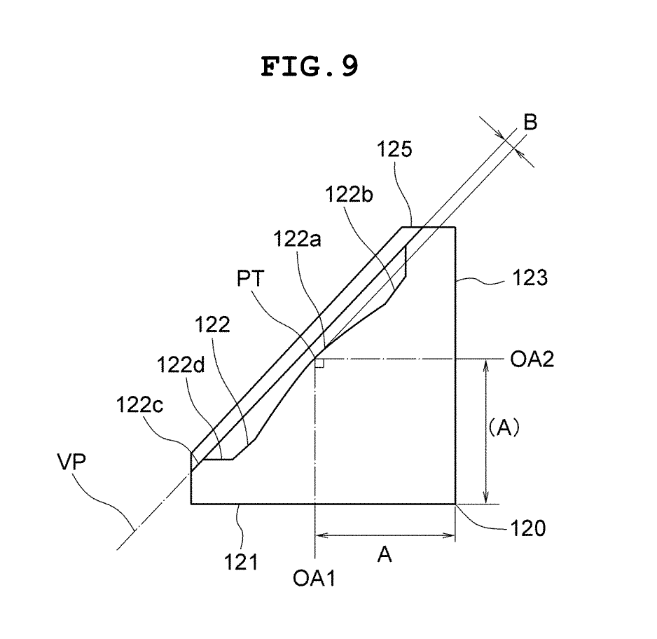

Hereinafter, embodiments of the present invention are described based on the drawings. FIG. 6 is a perspective view showing an optical coupling apparatus 100 including an optical path changing element as an optical element in one or more embodiments in a state of being disassembled. FIG. 7 is a cross sectional view along the optical axis of the optical coupling apparatus 100. FIG. 8 is a perspective view of the optical path changing element 120 used for the optical coupling apparatus 100. FIG. 9 is an enlarged cross sectional view of the optical path changing element 120. The constitution shown below is a schematic diagram, and the shapes and dimensions may be different from the actual shapes and dimensions.

As shown in FIGS. 6 and 7, the optical coupling apparatus 100 includes an optical module 110, an optical path changing element 120, and an optical connector 130. The optical module 110 has a function to transmit light rays in one or more embodiments, and can be installed in a substrate which is laminated in a plurality of stacked layers and inserted into a back surface of a large volume server. The substrate itself may be made into the optical module 110. The optical module 110 is constituted such that VCSEL type semiconductor lasers 112 serving as a plurality of light emitting elements are arranged in a single line on a rectangular base plate 111 with a top surface being a flat surface. The light source wavelength of the semiconductor lasers 112 is any one of 850 nm, 1310 nm, and 1550 nm. On the base plate 111, in the vicinity of each of the both ends of the semiconductor lasers 112 in the arrangement direction, a cylindrical pin 113 is disposed. On the perimeter of the semiconductor lasers 112, convexoconcave used for positioning the optical path changing element 120 may be formed. The optical module 110 has an NA of 0.1 to 0.6.

The optical connector 130 includes a main body 131 made of resin, is connected to the optical fibers 132, and has a function to hold this.

As the optical fibers 132, for example, all quartz type multimode type optical fibers, or single mode type optical fibers may be used. As the configuration of the optical fibers 132, a single core optical fibers may be used. However, in one or more embodiments, a multi core optical fiber tape (ribbon) which includes two or more optical fibers, is used.

The main body 131 is molded into a thicker rectangular plate shape, and, when viewing from an upper portion in FIG. 6, one side of the main body 131 is cut out in a rectangular shape so as to form a concave portion 131a. As shown in FIG. 7, on the side of the main body 131 opposite to the concave portion 131a, an insertion hole 131b into which the optical fibers 132 are inserted, is formed. The insertion hole 131b has a wide rectangular cross section so as to be able to accommodate a protecting portion 132a serving as covering of the optical fibers 132. From the bottom of the insertion hole 131b toward the concave portion 131a, a plurality of thin through holes 131c are formed. Into the through hole 131c, the distal end portion of a fiber bare wire 132b from which the covering of an optical fiber 132 is removed, is inserted.

The bottom surface 131d of the concave portion 131a on which each of the through holes 131c is exposed, is made orthogonal to an undersurface 131e of the main body 131. Moreover, as are shown in FIG. 6, a pair of circular openings 131f with the same diameter as the pin 113 are formed on the respective sides of the both sides of the concave portion 131a so as to sandwich the concave portion 131a.

In FIGS. 8 and 9, the optical path changing element 120 is formed integrally with resin into which a predetermined amount of glass fibers is mixed as mentioned later. The optical path changing element 120 has the form of an elongated triangular prism, and includes a first surface 121, a second surface 122, and a third surface 123. The first surface 121 is made orthogonal to the third surface 123. It is desirable from the viewpoint of miniaturization that the size, in the optical axis direction (the OA1, OA2 direction), of the optical path changing element 120 is 10 mm or less. Moreover, from the viewpoint that it is possible to make a size smaller than the minimum diameter at the time of bending the optical fiber, it is more desirable that the size is made to 5 mm or less. However, it is desirable that the length of a light ray passage passing through the inside of the optical element is about 1 mm. The length of the light ray passage made to 1 mm or less is preferable, because it becomes possible to use also a material with low transmittance. Conversely, in the case of the length of the light ray passage made larger than 1 mm, by using material with high transmittance, it becomes possible to secure sufficient transmittance as an optical path polarizing element.

The first surface 121 is a flat surface and has a function to allow light fluxes emitted from the semiconductor laser 112 of the optical module 110 to enter. The second surface 122 includes a plurality of reflective surfaces 122a disposed by being arranged along a single line, a flat joining surface 122b formed on the perimeter of the reflective surfaces 122a, and a rectangular frame-shaped protruding portion 122c formed on the outer periphery of the second surface 122 so as to surround the perimeter of the joining surface 122b. It is desirable that an inclined surface 122d is formed between the joining surface 122b and the protruding portion 122c. The third surface 123 is a flat surface and has a function to transmit light fluxes reflected from the reflective surfaces 122a.

Each of the reflective surfaces 122a has the same configuration that protrudes from the joining surface 122b, is shaped specifically in the form of an ellipse when being viewed from a front face, and has an anamorphic free curved surface capable of bending the optical axis of an entering conical divergent light flux by 90 degrees and reflecting the light flux as a conical convergent light flux. In an example shown in FIG. 8, the reflective surface 122a is shaped to a toroidal surface (an anamorphic surface in a broad sense) that is shaped in an ellipse in one direction. With this, aberration can be almost eliminated. The alignment interval of the reflective surfaces 122a is made equal to the alignment interval of the semiconductor lasers 112 of the optical module 110 and the alignment interval of the fiber bare wires 132b inserted into the through holes 131c. The alignment direction of the reflective surfaces 122a is made to a direction orthogonal to a plane including two optical axes of one of the reflective surfaces 122a. An angle (acute angle) formed by the tangential flat plane on the outer circumferential edge of the reflective surface 122a and the optical axis is usually made to 75 degrees or less. From the viewpoint of not affecting coupling efficiency, it is desirable that the distance between the protruding portion 122c and the reflective surface 122a is 0.05 mm or more.

The height of the protruding portion 122c from the joining surface 122b is made uniform over the whole perimeter, and larger than the protrusion amount of the reflective surface 122a. Accordingly, as shown in FIG. 9, in the case where a virtual plane VP is supposed so as to come in contact with the whole perimeter (here, the flat surface portion) of the protruding portion 122c, the virtual plane VP does not come in contact with the reflective surfaces 122a. Moreover, the virtual plane VP is made parallel to a tangential flat plane at an arbitrary point (in this example, the point is a point PT on the optical axis, however, the point is permissible if the point is at least a point located inside than the outer circumferential edge of the reflective surfaces 122a) of the reflective surfaces 122a.

In FIG. 9, in the case where the optical axis on the optical module 110 side in one of the reflective surfaces 122a is set to OA1 and the optical axis on the optical connector 130 side is set to OA2, the optical axis OA1 and the optical axis OA2 are orthogonal to each other on the reflective surface 122a. In the case where a distance from the first surface 121 to the reflective surface 122a along the optical axis OA1 (or a distance from the third surface 123 to the reflective surface 122a along the optical axis) is set to A and a distance from the point PT on the optical axis OA1 of the reflective surface 122a to the virtual plane VP is set to B, the following formula is satisfied. It should be noted that the distance A is usually 0.0625 mm or more and 2.9 mm or less.

B/A<1.0 (1)

In the optical path changing element 120, a parallel flat plate-like cover member 125 is bonded to the whole perimeter of the protruding portion 122c so as to overlap the virtual plane VP. In the case where the cover member 125 is a light blocking member, it is preferable, because it becomes possible to suppress the deterioration of the optical path changing element 120 and to prevent light rays from invading into the inside of a lens from the outside. The disposition of the cover member 125 causes a gap between the cover member 125 and the reflective surfaces 122a. Accordingly, there is no fear that the cover member 125 damages the reflective surface 122a and that, even in the case where a reflecting film is formed on the reflective surface 122a, the cover member 125 damages the reflecting film. In addition, since the cover member 125 can be disposed so as to overlaps the virtual plane VP, even in the case of laminating a substrate provided with the optical coupling apparatus 100, it is possible to contribute to the miniaturization in the lamination direction. Furthermore, the reflective surface 122a is sealed in a sealing space with the cover member 125, whereby the reflective surface 122a can be protected from the bad influence of the external environment, such as adhesion of foreign substances. Moreover, the gap between the reflective surface 122a and the virtual plane VP may be sealed with resin so as to prevent adhesion of foreign substances and dew condensation. The sealing with the cover member 125 or the resin is not necessarily performed. However, from the above-mentioned reasons, it is desirable to perform sealing with the cover member 125 or the resin. As shown in FIG. 9, it is desirable that the cover member 125 is configured not to protrude to the outside of the optical path changing element 120 at the time of being attached to the optical path changing element 120, because the optical coupling apparatus 100 can be miniaturized.

(Molding of an Optical Path Changing Element)

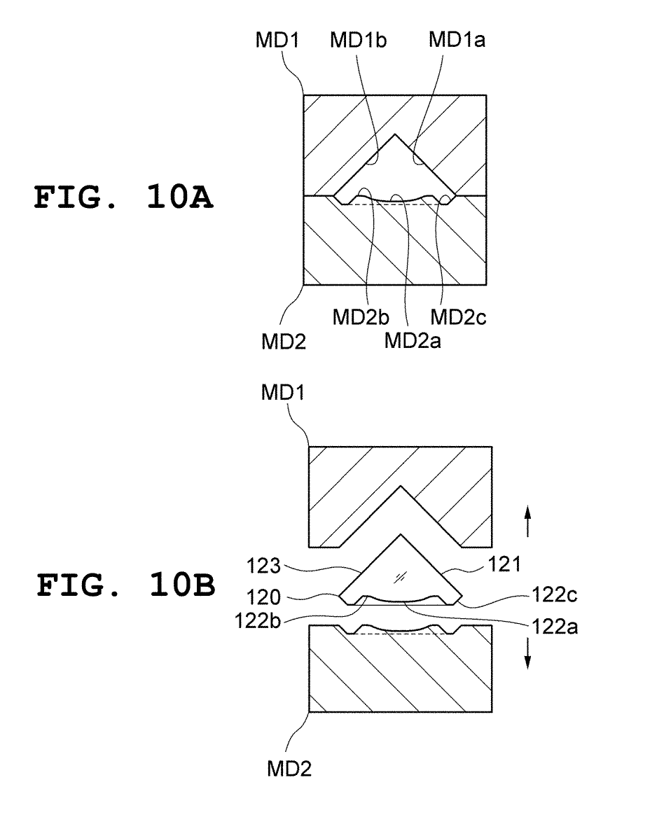

FIG. 10 is an illustration showing a molding process of an optical path changing element with resin. As shown in FIG. 10A, a first molding die MD1 has a V groove-shaped transferring surface including inclined surfaces MD1a and MD1b. On the other hand, a second molding die MD2 has an optical surface transferring surface MD2a, a joining surface transferring surface MD2b, and a protruding portion transferring surface MD2c. On the end surface of the second molding die MD2, as shown with a dotted line, the protruding portion transferring surface MD2c is locally enlarged. In a state of being clamped, each of the both sides of each of the first molding die MD1 and second molding die MD2 in the direction perpendicular to the sheet surface is closed except a gate.

In this example, the optical path changing element is molded by using the raw material into which 2 to 40 wt % glass fibers relative to resin are mixed. An elongated bar-shaped glass fiber is crushed, the crushed glass fibers are mixed with resin materials at a ratio of 2 to 40 wt %, the resulting mixed materials are put into an injection molding machine, and then, injection molding is performed. The resins and the glass fibers are selected such that a difference between the respective refractive index change rates (dn/dT) of the resins and the glass fibers relative to a temperature change at least in the vicinity of a light source wavelength is 10.5×10⁵ or less, and the glass fibers are mixed into the resins so as to obtain a resin material. Alternatively, the resins and the glass fibers are selected such that a difference between the respective linear expansion coefficients of the resins and the glass fibers at least within an operating temperature range is 6.0×10⁻⁵ or less, and the glass fibers are mixed into the resins so as to obtain a resin material. It is preferable that the transmittance of the resins in a state of being molded into a parallel plate with a thickness of 3 mm is 50% or more at light source wavelengths. It is preferable that the configuration of the glass fiber is a rod-like body with a cross section with a diameter of 5 to 50·m and a length of 10 to 500·m. The term “wt %” refers to weight %.

As shown in FIG. 10A, the first molding die MD1 and second molding die MD2 are clamped such that the undersurface of the first molding die MD1 and the top surface of the second molding die MD2 come to close contact with each other, and then, the melted resin material is made to flow from a not-shown gate into the cavities between the first molding die MD1 and second molding die MD2. At this time, it is desirable that the position of the gate is located at any place within the end surfaces (end surface in a direction perpendicular to the sheet surface shown partially with a dotted line in FIG. 10) of the first molding die MD1 and second molding die MD2.

With the inclined surface MD1 a of the first molding die MD1, the first surface 121 of the optical path changing element 120 is transferred and formed, and with the inclined surface MD1b, the third surface 123 is transferred and formed. On the other hand, with the optical surface MD2 a on the mold of the second molding die MD2, the reflective surfaces 122a of the optical path changing element 120 are transferred and formed, with the joining surface transferring surface MD2b, the joining surface 122b is transferred and formed, and with the protruding portion transferring surface MD2c, the protruding portion 122c is transferred and formed. Since the protruding portion transferring surface MD2c is separated away from the optical surface MD2a on the mold, there is little fear that the bad influence at the time of molding the protruding portion 122c with the protruding portion transferring surface MD2c affects the reflective surfaces 122a molded by the optical surface transferring surface MD2a, and the configuration of the reflective surfaces 122a can be maintained with sufficient accuracy.

As shown in FIG. 10B, after the solidification of the resin material, the first molding die MD1 and the second molding die MD2 are opened and separated from each other, whereby the molded optical path changing element 120 can be taken out. According to one or more embodiments, since each of the first surface 121 and the third surface 123 of the optical path changing element 120 is a flat surface, even if the single first molding die MD1 is used, the molding dies can be released easily.

Hereinafter, a preferable mode of the above-mentioned optical element is described collectively.

In the above-mentioned optical element, it is preferable that the transmittance of the above-mentioned resin in a state of being molded into a parallel flat plate with a thickness of 3 mm is 50% or more relative to a light flux with the light source wavelengths.

According to the examination results of the present inventors, in the case where the transmittance of the above-mentioned resin in a state of being molded into a parallel flat plate with a thickness of 3 mm is made to 50% or more relative to a light flux with the light source wavelengths, with an antireflection coat applied to each of the both surfaces of the plate, an improvement in transmittance of about 5% on one surface can be expected. Accordingly, it becomes possible to secure a transmittance of 60% (internal resorption component of 40%) in total. In many cases, in actual optical elements, since the length of a light ray passage passing through the inside of an optical element is about 1 mm, an internal resorption component becomes 13% (40%/3 mm). Accordingly, it becomes possible to obtain a product transmittance of 87%, which is preferable.

Moreover, it is preferable that the above-mentioned resin is any of polycarbonate (PC), polymethyl methacrylate (PMMA), polyolefin resins, transparent polyamide (PA), polysulfone (PSU)/polyphenylene sulfone (PPSU), polyether sulfone (PES), polyether imide (PEI), and polyetheretherketone (PEEK). Since such resins are excellent in transparency and has good compatibility with glass fillers, they are suitable as the raw materials of an optical element.

Moreover, the mixing (mixing-into) amount of glass fillers is preferably 2 to 40wt %. In the case where the mixing-into amount of the glass fillers is made 2wt % or more, it becomes possible to obtain effects sufficient to adjust a linear expansion coefficient. On the other hand, in the case where the mixing-into amount of the glass fillers is made 40wt % or less, it becomes possible to avoid bad influences, such as deterioration of moldability and operation failure of injection. Furthermore, even if the mixing-into amount of the glass fillers is too much, there is also a side aspect that the effect of adjustment of a linear expansion coefficient is small.

Moreover, the glass fillers are preferably glass fibers. The glass fibers being fine rod-like body have an effect to adjust a linear expansion coefficient easily by being mixed in resin.

Furthermore, the configuration of the glass fibers is a rod-like body with a cross section with a diameter of 5 to 50·m and a length of 10 to 500·m. With this, general glass fibers can be used.

Moreover, the light source wavelength is preferably any one of 850±150 nm, 1310±150 nm, and 1550±150 nm. Since such a light source wavelength is frequently used in optical communication, it is desirable that it can deal with this.

Moreover, the above-mentioned optical element is preferably an optical element that is used for optical communication and has optical surfaces aligned in an array form.

Hereinafter, description is given to examples usable in the above-mentioned embodiments. Here, a case of using only general purpose PC (polycarbonate) material was made into Comparative Example 1, furthermore, Comparative Example 2 was prepared by mixing glass fibers (product name: FF5) manufactured by Hoya Corporation into the same PC material, and Example 1 was prepared by mixing glass fibers (product name: BACD12) manufactured by Hoya Corporation into the same PC material. Then, a peak wavelength deviation amount, a refractive index for each wavelength, a refractive index change rate (dn/dT) relative to a temperature change (normal temperature+55° C.), a difference between the respective refractive index change rates (dn/dT) of the PC material (resin) and the glass fibers relative to a temperature change, a linear expansion coefficient in an operation temperature range, and a difference between the respective linear expansion coefficients of the PC material (resin) and the glass fibers were obtained, and the obtained values were compared with each other. In the calculation of do/dT in the vicinity of the light source wavelength, an approximate curve may be used. In the Comparative Examples and Examples, refractive indexes at the light source wavelengths·=486 nm, 587 nm, and 656 nm are approximated with a linear curve, and then the value of do/dT was calculated. The results are shown in Table 1.

TABLE 1

| | Peak wavelength | | | | | | | |
|---|---|---|---|---|---|---|---|---|
| | deviation amount | | | | | | | |
| | in mixed-into | | | | | | | |
| | molded-product | | | | | Difference in | Linear | Difference in linear |
| | normal temperature | Refractive index | | | | dn/dT for | expansion | expansion coefficient |
| | to 55° C. | λ486 nm | λ587 nm | λ656 nm | dn/dT | PC material | coefficient | for PC material |
| Comparative | — | 1.596 | 1.583 | 1.577 | 10.9 × 10⁻⁵ | 0 | 6.5 × 10⁻⁵ | 0 |
| Example 1 | | | | | | | | |
| only PL | | | | | | | | |
| Comparative | 27 nm | 1.605 | 1.593 | 1.588 | 0.1 × 10⁻⁵ | 10.8 × 10⁻⁵ | 0.1 × 10⁻⁵ | 6.4 × 10⁻⁵ |
| Example 2 | | | | | | | | |
| PL + GF | | | | | | | | |
| Example 1 | 12 nm | 1.590 | 1.583 | 1.580 | 0.4 × 10⁻⁵ | 10.5 × 10⁻⁵ | 0.5 × 10⁻⁵ | 6.0 × 10⁻⁵ |
| PL + GF | | | | | | | | |

From the comparison results in Table 1, in Comparative Example 2, a difference between the respective refractive index change rates (dn/dT) of the resin and the glass fibers relative to the temperature change in the light source wavelength (587 nm) was 10.8×10⁻⁵, a difference between the respective linear expansion coefficients of the resin and the glass fibers in the operation temperature range of the optical element was 6.4×10⁻⁵, and a peak wavelength deviation amount was 27 nm. In contrast, in Example 1, a difference between the respective refractive index change rates (dn/dT) of the resin and the glass fibers relative to the temperature change was 10.5×10⁻⁵, a difference between the respective linear expansion coefficients o the resin and the glass fibers in the operating temperature range of the optical element was 6.0×10⁻⁵, and a peak wavelength deviation amount was reduced to 12 nm being the half of the above value. Based on the consideration for the above results, as the refractive index change rate dn/dT of the glass fibers mixed into the resin relative to a temperature change is closer to the refractive index change rate dn/dT of the resin, it is presumed that the peak wavelength deviation amount can be suppressed. Moreover, the linear expansion coefficient of the glass fibers mixed into the resin is closer to the linear expansion coefficient of the resin, it is presumed that the peak wavelength deviation amount can be suppressed.

It is clear for a person skilled in the art from the embodiments and examples written in the present specification and technical concepts that the present invention should not be limited to the embodiments and examples written in the present specification, and includes other embodiments and examples, and modification embodiments. For example, the optical element of the present invention can be used for a collimator of a small type projector and an optical pickup apparatus without being limited to the optical communication.

### REFERENCE SIGNS LIST

100 Optical Coupling Apparatus
110 Optical Module
111 Base Plate
112 Semiconductor Laser
113 Pin
120 Optical Path Changing Element
121 First Surface
122 Second Surface
123 Third Surface
125 Cover Member
130 Optical Connector
131 Main Body
131a Concave portion
131b Insertion Hole
131c Through Hole
131d Bottom Surface
131e Undersurface
131f Circular Opening
132 Optical Fiber
132a Protecting Portion
132b Fiber Bare wire

1. An optical element that transmits a light flux emitted from a light source having a single light source wavelength,
wherein the optical element is formed from a material in which resin and glass fillers are mixed, and a difference between respective refractive index change rates (dn/dT) of the resin and the glass fillers relative to a temperature change at least in a vicinity of the light source wavelength becomes 10.5×10⁻⁵ or less.

2. An optical element that transmits a light flux emitted from a light source having a single light source wavelength,
wherein the optical element is formed from a material in which resin and glass fillers are mixed, and a difference between respective linear expansion coefficients of the resin and the glass fillers at least in an operating temperature range of the optical element becomes 6.0×10⁻⁵ or less.

3. The optical element described in claim 1, wherein transmittance of the resin in a state of being molded into a parallel flat plate with a thickness of 3 mm is 50% or more relative to light with the light source wavelength.

4. The optical element described in claim 1, wherein the resin is one selected from a group consisting of polycarbonate (PC), polymethyl methacrylate (PMMA), polyolefin resins, transparent polyamide (PA), polysulfone (PSU)/polyphenylene sulfone (PPSU), polyether sulfone (PES), polyether imide (PEI), and polyetheretherketone (PEEK).

5. The optical element described in claim 1, wherein a mixed amount of the glass fillers is 2 to 40 wt %.

6. The optical element described in claim 1, wherein the glass fillers are glass fibers.

7. The optical element described in claim 6, wherein each of the glass fibers has a configuration of a rod-like body with a cross section with a diameter of 5 to 50 μm and a length of 10 to 500 μm.

8. The optical element described in claim 1, wherein the light source wavelength is one selected from a group consisting of 850±150 nm, 1310±150 nm, and 1550±150 nm.

9. The optical element described in claim 1, wherein the optical element has optical surfaces used for optical communication arranged in an array form.

10. A method of manufacturing an optical element that transmits a light flux emitted from a light source having a single light source wavelength and is formed from a material in which resin and glass fillers are mixed, the method comprising:
mixing resin and glass fillers such that a difference between respective refractive index change rates (dn/dT) of the resin and the glass fillers relative to a temperature at least in a vicinity of the light source wavelength change becomes 10.5×10⁻⁵ or less;
injecting the mixed materials into a cavity formed in a mold;
cooling the mixed material in the mold so as to mold an optical element;
and
taking out the molded optical element.

11. A method of manufacturing an optical element that is configured to transmit a light flux emitted from a light source having a single light source wavelength and is formed from a material in which resin and glass fillers are mixed, the method comprising:
mixing resin and glass fillers such that a difference between respective linear expansion coefficients of the resin and the glass filler at least in an operating temperature range of the optical element becomes 6.0×10⁻⁵ or less;
injecting the mixed materials into a cavity formed in a mold;
cooling the mixed material in the mold so as to mold an optical element;
and
taking out the molded optical element.

12. The optical element described in claim 2, wherein transmittance of the resin in a state of being molded into a parallel flat plate with a thickness of 3 mm is 50% or more relative to light with the light source wavelength.

13. The optical element described in claim 2, wherein the resin is one selected from a group consisting of polycarbonate (PC), polymethyl methacrylate (PMMA), polyolefin resins, transparent polyamide (PA), polysulfone (PSU)/polyphenylene sulfone (PPSU), polyether sulfone (PES), polyether imide (PEI), and polyetheretherketone (PEEK).

14. The optical element described in claim 2, wherein a mixed amount of the glass fillers is 2 to 40 wt %.

15. The optical element described in claim 2, wherein the glass fillers are glass fibers.

16. The optical element described in claim 15, wherein each of the glass fibers has a configuration of a rod-like body with a cross section with a diameter of 5 to 50 μm and a length of 10 to 500 μm.

17. The optical element described in claim 2, wherein the light source wavelength is one selected from a group consisting of 850±150 nm, 1310±150 nm, and 1550±150 nm.

18. The optical element described in claim 2, wherein the optical element is an optical element in which optical surfaces used for optical communication are arranged in an array form.
